(19) United States
(12) Patent Application Publication
(10) Pub. No.: US 2005/0091604 A1
(43) Pub. Date: Apr. 28, 2005

(54) Systems and methods that track a user-identified point of focus

(76) Inventor: Scott Davis, North Vancouver (CA)

Correspondence Address: Milan Patel;c/o Nokia Mobile Phones (Patent Dept.), Mail Stop 1-4-755, 6000 Connection Drive, Irving, TX, 75039, US

(21) Appl. No.: 10/691,715

(22) Filed: Oct. 22, 2003

(51) Int. Cl. G06F 3/00

(52) U.S. Cl. 715/772; 715/833; 715/767; 715/784; 715/785; 715/786; 715/787; 715/802; 715/822; 715/823; 715/974

(57) ABSTRACT

The present invention relates to systems and methods that associate graphical indicia with a scroll bar, wherein the graphical indicia provides a relative location of a user-identified focus point within a set of data. The graphical indicia can be employed by the user to efficiently navigate through the data in order to position the focus point within a viewing window of a user interface. In one aspect, the user can manually maneuver a slider associated with scroll bar proximate to the graphical indicia to position the focus point with the viewing window. In another aspect, the user can invoke the graphical indicia to automatically position the focus point within the viewing window. Furthermore, the systems and methods of the present invention provide for multiple foci to be identified, associated with respective graphical indicia and tracked, and multi-dimensional tracking via a plurality of scroll bars and respective sliders.

### TECHNICAL FIELD

The present invention generally relates to microprocessor-based devices, and more particularly to systems and methods that provide a mechanism to tag an item of interest within a list and subsequently utilize the tag to return to the item of interest.

### BACKGROUND OF THE INVENTION

Graphical user interfaces (GUIs) are commonly employed in connection with microprocessor-based devices such as computers to view information (e.g., a document, spreadsheet, etc.). In many instances, the amount of information that a user desires to observe exceeds a data-viewing window associated with a GUI. Conventionally, techniques such as utilizing a monitor with a larger display, adjusting the display resolution, modifying the font size/type and “zooming out,” for example, can be employed to scale the information to fit within the viewing window; however, such techniques can be limited by the hardware and/or software associated with the microprocessor-based device and/or the user's visual discernment.

For example, the combination of display size, resolution (e.g., monitor and graphics card) and/or software application may not permit all of the information to be fit within the viewing window. In another example, even if all the information could be fit into the viewing window, the information may not be readable by the user when it is fit within the viewing window. For example, a list can include virtually an infinite number of entries (e.g., lines, cells, fields, entries, columns and rows, etc.), wherein fitting even a portion of the list within the viewing window, let alone the entire list, can render the information essentially unreadable to the user.

Another technique includes implementing one or more positioning mechanisms (e.g., scroll bars) that enable a user to navigate through the information. Thus, the user can adjust one or more settings to obtain a desired level of readability, wherein only a portion of the information is within the viewing window at any moment in time. The user can then employ the positioning mechanism to change the portion of information within the viewing window, as desired. The foregoing mechanism can provide the user with a means to locate one or more items of interest within the information (e.g., items of interest disparately positioned), wherein at least one item of interest is not visible to the user (e.g., not within the viewing window) while at least one other item of interest is visible to the user (e.g., within the viewing window).

By way of example, a user can view an electronic library of music that comprises hundreds or thousands of artists and associated music. The information within the library can include artist name, group name, song title, album title, year, etc., wherein the information can be delineated based on genre, artist name, recording title, year, song name, etc. Conventionally, the user navigates through the information, wherein only a portion of the information is displayed within the viewing window. As the user observes an item of interest, the user can make a mental and/or physical note (e.g., a page number, approximate location (e.g., about half way through), a key word, and the like) in order to locate and return to the item at a later time.

The mental and/or physical note enables the user to navigate to other portions of information such that the item of interest eventually is removed from the viewing window. In many instances, the user can forget the noted location and/or the item of interest as the user navigates and locates more and more items of interest. Thus, when the user desires to return to one or more of the items of interest, the user may not be successful with locating any item of interest. In other instances, the user simply ends up randomly re-scrolling through the information again and again to relocate one or more items of interest or in hope of observing a pattern, a keyword, etc. that may refresh the user's memory. In yet other instances, the user may never remember or locate a particular item of interest.

Such conventional techniques can be inefficient, time consuming and irritating to the user, especially when the user cannot remember and/or relocate an item of interest. Thus, there is a need for a more efficient and user-friendly technique to locate items of interest within a set of information.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention relates to systems and methods that track a user-identified item of interest in order for a user to quickly return to the item. In general, when a user views a list of items, the quantity of data within the list can be such that it exceeds a viewing window. For example, the user can open a file that comprises over one hundred pages of text, images, charts, tables, etc. Typically, the user displays a portion of a page within the viewing window, while the remainder of the page and file reside outside of the viewing window. In many instances, the user can scale the file in order to view an entire page within the area wherein the data remains readable. However, as the user begins to view more pages (e.g., two, three, four, etc.) concurrently, respective pages and hence the data within the pages can become unreadable.

Conventional systems commonly provide a scrolling device that allows the user to dynamically select the portion to view at any given time, wherein the user can change the portion within the viewing window simply by employing the scrolling device to advance to a different portion of the file. However, as the user advances to different portions, previous portions are removed from the viewing window. If the user decides to return to a particular item that was previously viewed, the user re-scrolls through the file until the item is located. Such a technique can be inefficient, time consuming and irritating to the user, for example, when the user cannot relocate the item and re-scrolls through the file several times.

The systems and methods of the present invention mitigate utilizing such techniques via providing a graphical indication of the relative location of an item of interest within a list (e.g., a file) that enables the user to quickly return to the item. In general, the user identifies the item and then the location of the item is determined and associated with graphical indicia. When the user desires to view the item, the user can manually adjust the scrolling mechanism based on the graphical indicia and/or invoke the graphical indicia to automatically return the item to the viewing window.

In one aspect of the present invention, a system is provided that provides a component that accepts an input such as an event, an IRQ, a flag, a request, a signal and the like that can indicate a user's desire to track an item. The component can obtain and store the location of the item and subsequently retrieve the saved location upon a user request to return the user to the tracked item. In addition, the system provides the user with the capability to halt tracking an item. Moreover, the component can be utilized to concurrently track one or more items.

In another aspect of the present invention, a user interface is provided that comprises a scroll bar and associated slider, wherein the slider allows the user to navigate through data to selectively view portions of the data within a viewable window of the user interface. The user interface further includes the ability to generate a graphical indicator(s) and associate the graphical indicator(s) with the scroll bar. The graphical indicator(s) is generated in response to the user identifying a focus item(s) within a set of items. The graphical indicator(s) maintains its position with respect to the scroll bar as the user navigates throughout the set of items and provides the user with the relative location of the focus item(s) within the set of items. The user can quickly return to the focus item(s) via maneuvering the slider proximate to the focus indicator(s) and/or invoking the focus indicator(s). The systems and methods of the present invention contemplate user interfaces that employ multi-dimensional tracking approaches, multi item tracking and various scroll bar shapes.

In another aspect of the present invention, methodologies are provided to add and remove focus indicia from a scroll bar and to employ the focus indicia to return points of focus to a user. Adding focus indicia includes identifying points of focus, determining the location of the points of focus within a set of data, storing the location for later retrieval and creating and associating the focus indicia. Removing focus indicia comprises removing the highlighting from respective focus points and/or deleting the focus indicia. Returning to a focus point includes determining the focus indicia associated with the desired data and either employing a slide associated with the scroll bar to navigate to the focus point or invoking the focus indicia.

To the accomplishment of the foregoing and related ends, certain illustrative aspects of the invention are described herein in connection with the following description and the annexed drawings. These aspects are indicative, however, of but a few of the various ways in which the principles of the invention may be employed, and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 illustrates an exemplary system that tracks at least one user-identified item within a plurality of items via the location of the at least one user-identified item within the plurality of items, in accordance with an aspect of the present invention.

FIGS. 2-5 illustrates an exemplary user interface that tracks a focus point via a focus point indicator associated with a scroll bar, in accordance with an aspect of the present invention.

FIGS. 6-9 illustrates an exemplary user interface that tracks user-identified foci via foci indicators associated with a scroll bar, in accordance with an aspect of the present invention.

FIG. 10 illustrates an exemplary system that employs a multi-dimensional approach to tracking one or more focus points, in accordance with an aspect of the present invention.

FIG. 11 illustrates an exemplary methodology that associate a graphical indicator with a focus point, in accordance with an aspect of the present invention.

FIG. 12 illustrates an exemplary methodology that removes a focus point graphical indicator, in accordance with an aspect of the present invention.

FIG. 13 illustrates an exemplary methodology that positions a tracked item within a window visible to a user via a graphical indicator associated with the tracked item, in accordance with an aspect of the present invention.

FIG. 14 illustrates an exemplary flow diagram that generates tracking indicia, in accordance with an aspect of the present invention.

FIGS. 15-17 illustrates an exemplary scrolling mechanisms that can be employed in connection with the novel aspects of the present invention.

FIG. 18 illustrates an exemplary intelligence-based system that tracks foci, in accordance with an aspect of the present invention.

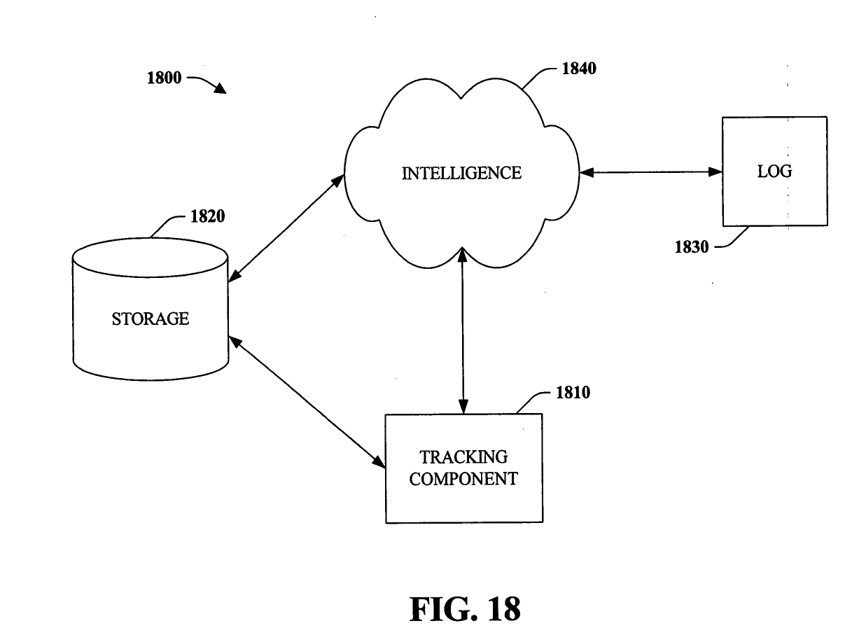

FIG. 19 illustrates an exemplary mobile device wherein the invention can be employed.

FIG. 20 illustrates an exemplary computing environment wherein the invention can be employed.

### DETAILED DESCRIPTION OF THE INVENTION

The present invention relates to systems and methods that enable a user to return to a point of interest within a set of data via a graphical indicator that is generated and associated with the location of the point of interest. In general, the user identifies an item as a point of interest, or focus and subsequently a graphical indicator is generated for the point of interest and associated with a scroll bar and slider. The user can then navigate through the data via maneuvering the slider in connection with the scroll bar such that the point of interest is no longer within a viewing window of a user interface. The user can then return the point of interest to the viewing window by moving a slider proximate to the graphical indicator and/or invoking the graphical indicator.

As used in this application, the term “list” can include any grouping of one or more items. For example, a file such as a word processing document can be referred to as a list of characters (e.g., alphanumeric, codes and symbols), words, lines, paragraphs and/or pages, including graphics and nullities. In another example, a tree diagram illustrating a file structure that depicts various files and folders can be referred to as a list of files and folders. Other examples include tables, charts, spreadsheets, and the like. It is to be appreciated that virtually any known grouping, including groupings of one, can be referred to as a list in accordance with an aspect of the present invention.

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

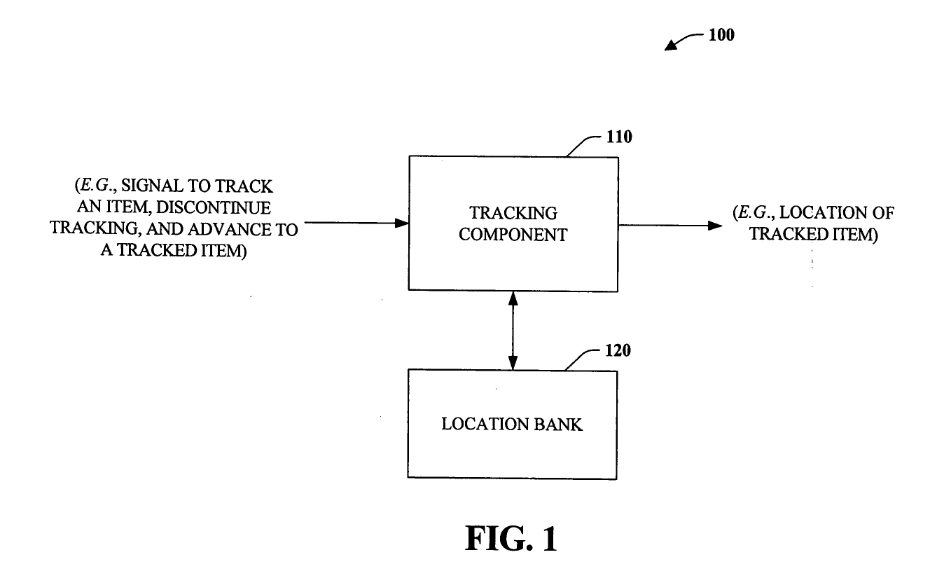

FIG. 1 illustrates an exemplary system 100 that tracks at least one user-identified item within a plurality of items, in accordance with an aspect of the present invention. The system 100 comprises a tracking component 110 that coordinates tracking the user identified item(s) and a location bank 120 wherein the tracking information can be stored and retrieved.

The tracking component 110 can accept an input indicative of a user's desire to commence tracking a selected item, sever tracking an item and return a user to a tracked item, for example. The input can be an event, an IRQ, a signal, a flag, a request, and the like. In addition, the input can include information such as the location of the item and an item unique identification, for example, which can be saved and subsequently utilized to locate the tracked item. The output of the tracking component 110 generally includes the location of a tracked item and is provided after receiving a return to tracked item input.

Upon receiving an input to begin tracking an item, the tracking component 110 obtains a location of the item. As noted above, the location of the item can be included with the input. Typically, the location can include, for example, coordinates (e.g., x, y and/or z) that denote the location of the item within a list (e.g., as described above) of items. Such location can be transmitted serially or concurrently with the input. In one example, the location of the item can be conveyed after an acknowledgment is transmitted by the tracking component 110, wherein the acknowledgement can indicate that the tracking component 110 is ready to receive the location information. Thus, if the tracking component 110 is unable track the item (e.g., the number of presently tracked items exceeds a threshold, the tracking component 110 is currently servicing a request and the tracking component 110 is inoperable), the system 100 can minimize overhead by mitigating the transmission of the location. It is to be appreciated that when the tracking component 110 is unable to service the input that the input can be queued and/or the input can be re-sent at a later time. In another aspect of the present invention, the tracking component 110 can determine the location and/or request such information from another component (not shown).

After obtaining the location of the item to track, the tracking component 110 can store the location within the location bank 120. In addition to the location, an identifier such as the unique identifier transmitted with the input and/or a generated unique identification can be associated and stored with the location to facilitate subsequent retrieval of the location from the location bank 120. Furthermore, a graphic can be created to provide the user with a visual indication of the position of the tracked item relative to the other items within the entity. The graphic can additionally be linked to the location bank 120 such that the location of the tracked item can be obtained through the graphic. For example, invoking the graphic can elicit retrieval of the location of the tracked item from the location bank 120.

Upon receiving an input to end tracking a particular item, the tracking component 110 can remove the location of the tracked item and any additional information such as identifiers from the location bank 120. It is to be appreciated that stored location information for more than one item, including all items, can be concurrently removed from the location bank 120. In addition, the tracking component 110 can be configured to prompt the user for verification prior to removing location information. In other instances, the user can configure the tracking component 110 such that after a time period lapses, tracking information that has been stored without any subsequent utilization can be automatically removed from the location bank 120. Thus, rather than having the user initiate the removal through an action, the tracking component 110 can infer from an inaction that the user no longer desires to track the item. In still other instances, the user can undo the removal of a previously tracked item, wherein the location, any unique identification and/or graphic can be re-stored.

When receiving an input to return to a tracked item, the tracking component 110 can retrieve the location of the tracked item from the location bank 120. The location can then be employed to return to the item. For example, when employed in connection with a user interface, a pop-up box can be invoked that provides the user with the location, wherein the user can advance to the location, and hence the tracked item, manually or automatically. Additionally, the pop-up box can provide the user with a mechanism to back out, or cancel the request. In another example, an alphanumeric and/or audio message or notification can be provided that includes the location. In yet another example, the tracking component 110 can be configured to automatically go to the location after sensing the input. In still another example, the graphic can be invoked to return the user to the tracked item. In other examples, a slider and scroll bar can be employed, wherein the slider can be advanced proximate a graphic to return the tracked item to a viewing window.

It is noted that returning a tracked item to a user and returning the user to the tracked item can refer to positioning information within a user interface viewing window such that information is visible to the user. For example, a list can include a volume of items that cannot be displayed with the viewing window in a readable manner. Under such circumstances, a subset of the list can be defined such that displaying the subset within the viewing window provides the user with a readable list of items. If the user selects an item within the viewing window to track and then navigates through the other items such that the tracked item is no longer within the viewing window, the user can re-position the items such that the tracked item falls within the viewing window. Such re-positioning can be referred to as either returning the tracked item to the user or returning the user to the tracked item, since in both instances, the tracked item resides within the viewing window and is visible to the user.

It is to be understood that the location bank 120 can be any known storage medium. For example, the storage bank 120 can be local memory (e.g., non-volatile and volatile) associated with the tracking component 110. In another example, the location bank 120 can be a common area accessed via a network. In yet another example, the storage bank 120 can reside in connection with one or more other tracking components in a shared environment. For example, a first user can begin tracking several items of interest to other users. In the shared environment, the other users can be provided with access to the first user's location bank, which mitigates respective users having to consume time selecting and commencing tracking that would render redundant tracking. In still another example, portable storage such as CD, DVD, tape, optical disk, memory stick, flash memory, and the like can be utilized.

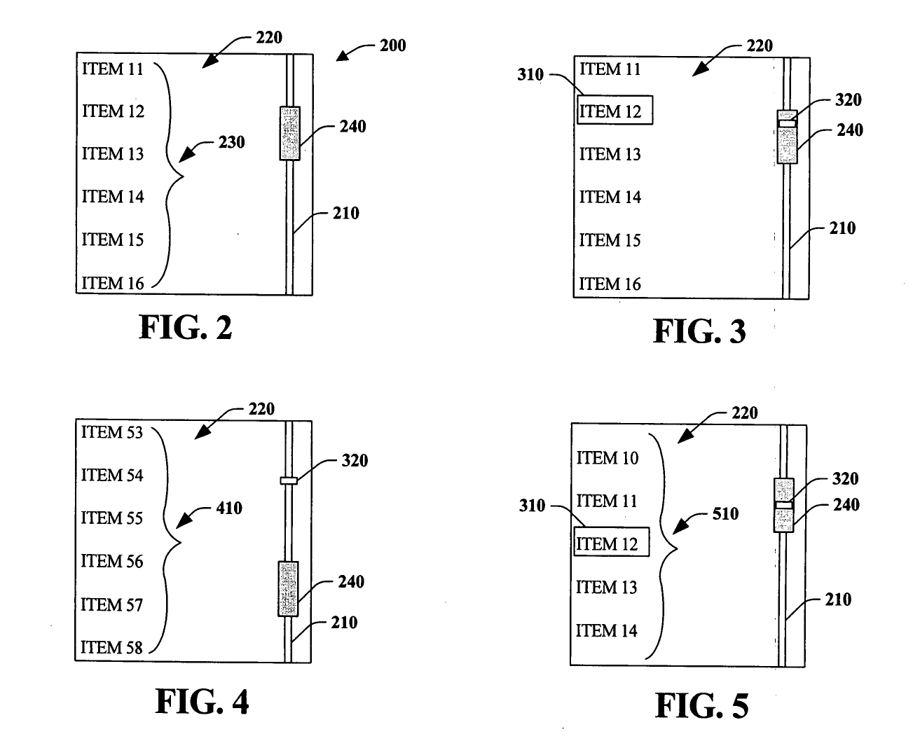

FIGS. 2-5 illustrate an exemplary user interface (UI) 200 that employs the novel aspects of the present invention. For sake of clarity and brevity of explanation, the UI 200 is depicted and described as a rectangular area that can be navigated via a slider associated with a scroll bar; however, it is to be understood and appreciated that the present invention is not so limited. For example, the novel aspects of the present invention can be employed in connection with other interfaces such as command line interfaces, audio interfaces and environments that contemplate user's without visual and/or audio ability, and various other navigational mechanisms such as thumb controls, roller balls, and key strokes.

Referring initially to FIG. 2, the UI 200 comprises a scroll bar 210 that typically represents the extent of a list, wherein one end of the scroll bar 210 generally is indicative of a beginning of the list and an opposing end of the scroll bar 210 generally is indicative of an end of the list. However, it is to be appreciated that the scroll bar 210 can be variously configured, for example, to map to a subset within the list, wherein portions outside of the defined subset are not viewable within the UI 200. The foregoing subset can reduce memory consumption and increase response time when the user is aware that portions, or items within the entity will not be viewed.

The scroll bar 210 can be vertically oriented, as depicted, with respect to a viewing region 220. However, it is to be appreciated that the vertical representation is illustrative and not limitative. For example, the scroll bar 210 can be positioned horizontally (as described in detail below) or at angles (e.g., orthogonal, parallel, acute and obtuse) with respect to a user-defined axis within the viewing region 220. In addition, the scroll bar 210 can be variously shaped (e.g., curved), wherein the user can dynamically change the shape as desired. Moreover, the scroll bar 210 can free-float outside, in front of or behind the viewing region 220, wherein the user can access the scroll bar 210 to navigate through the entity.

The viewing region 220 can provide a visible area, or window in which the user can view a portion of (e.g., items within) the list or the entire lsit. As noted previously, the relative size of the list can be such that it would be unreadable if viewed in its entirety within the visible area. In such instances, the user can select a portion to present within the viewing region 220. As depicted, the viewable region 220 includes a first portion 230 that comprises items 11-16.

The user can select the portion 230 via moving a slider 240 in connection with the scroll bar 210. Typically, the slider 240 is illustrative of a region within the list and a percentage of viewable items within the list. For example, the slider 240 is located between the ends of the scroll bar 210 and more proximate to one end. Such positioning can imply that the portion of the list within the viewing region 220 does not represent the beginning, the end or the entire list, but a region closer in proximity to one end. More specifically, the slider 240 is positioned such that items 11-16 are within the viewing region 220. Thus, the slider 240 provides a general indication of the location of the portion within the viewing region 200 relative to the list.

The percentage of the portion 230 within the viewing region 220 typically is illustrated via the size of the slider 240. For example, the slider 240 is about one fourth the length of the scroll bar 210. In accordance with an aspect of the invention, such length can indicate that one fourth of the list is within the viewing region 220. In other aspects of the invention, the width can additionally or alternatively be employed to indicate the percentage of the list that is within the viewing region 220.

In general, the slider 240 can be moved via various mechanisms, including a mouse (e.g., click and drag), one or more buttons (e.g., arrow keys), an audio command, a roller ball, a thumb switch, and touch screen technology, for example.

It is to be appreciated that the viewing region 220 can include any known utilities that are commonly provided in graphical and command line interfaces. For example, the viewing region 220 can comprise known text and/or graphic presenting regions comprising dialogue boxes, static controls, drop-down-menus, list boxes, pop-up menus, graphic boxes, and navigational tools. The user can interact with the presenting regions to select and provide information via various devices such as a mouse, a roller ball, a keypad, a keyboard, a pen and/or voice activation, for example.

The viewing region 220 can additionally include input regions, which can be utilized to obtain information. The input regions can employ similar mechanism (e.g., dialogue boxes, etc.), and in addition provide utilities such as edit controls, combo boxes, radio buttons, check boxes, and push buttons, wherein the user can use the various input devices (e.g., the mouse, the roller ball, the keypad, the keyboard, the pen and/or voice activation) in connection with the mechanism and utilities. For example, the user can select an item within the presenting region via highlighting the item. Furthermore, the viewing region 220 can include access to a command line interface. The command line interface can prompt the user via a text message on a display and an audio tone. The user can then provide suitable information, such as alpha-numeric input corresponding to an option provided in the interface prompt or an answer to a question posed in the prompt.

It is to be appreciated that the UI 200 can be constructed through a tool, utility and/or API. In addition, the UI 200 can be employed in connection with hardware such as video cards, accelerators, signal processors and the like to improve performance and enhance the user's experience.

FIG. 3 illustrates the UI 200, wherein the user indicates a focus point 310 to track via selecting “ITEM 12” within the viewing region 220. It is to be appreciated that various techniques can be employed to designate a focus point. For example, a focus point can be outlined via a box (as depicted), highlighted (e.g., via a background and overlay), shaded, backlit, and/or modified (e.g., a change in font size, type, color and/or format), in accordance with an aspect of the present invention. In addition, the focus point can be indicated via audio techniques including voice activated or facilitated selection.

Upon identifying the focus point 310 within the viewing region 220, a focus indicator, a tag 320 can be generated and associated with the scroll bar 210 and the slider 230. In general, the tag 320 is associated with an area of the scroll bar 210 that illustrates the relative position of the focus point 310 within the list and within an area of the slider 240 that illustrates the relative position of the focus point 310 within the viewing region 220 when the slider is positioned such that the focus point 310 is within the viewing region 220. In addition, the tag 320 can provide information (e.g., via size) related to the percentage of information that the focus point 310 represents relative to the scroll bar 210 and viewable region indicator 240.

It is to be appreciated that the user can remove or modify the tag 320 and/or add one or more other tags. For example, if the user decides that the highlighted item is not or is no longer a focus point, then the user can unhighlight the item and/or delete the tag 320. In addition, the user can move the tag 320, which can automatically move the highlighting from one item to another item, which can automatically change the focus point. Furthermore, and as will be discussed in detail below, the user can highlight one or more additional foci, wherein corresponding tags can be generated and associated with the scroll bar 210 and viewable region indicator 240. Briefly, when multiple tags are created, various techniques can be employed to differentiate the tags. For example, tags can be color-coded and/or differ in shape and/or size. In addition, overlapping tags can be configured with opacity and/or translucency such that a user can view one or more overlapped tags.

FIG. 4 illustrates the UI 200, wherein the user has moved to a different position with the list such as a second portion 410. As noted previously, the user can navigate through the list via the slider 240, keystrokes and/or audio commands. The second portion 410 provides the user with visible access to items 53-58, which does not include the focus point 310.

The user can continue to navigate through the list to bring various other portions of the list within the viewing region 220. Regardless of the portion displayed within the viewing region 220, the tag 320 for the focus point 310 remains associated with the scroll bar 210. Thus, when the slider 240 is moved such that the focus point 310 is no longer visible within the viewing region 200 (as depicted), and hence the tag 320 no longer resides within the slider 240, the tag 320 maintains its relative position in connection with the scroll bar 210 to provide the user with the location of the focus point 310 within the list.

FIG. 5 illustrates the UI 200 after the user returns to the focus point 310. In one aspect of the present invention, the user can return to the focus point 310 by invoking the tag 320, for example, via clicking (e.g., single and double) on the tag 320 and/or uttering an identification of the tag 320. Upon invocation of the tag 320, a portion 510 that includes the focus point 310 can be automatically shown within the viewing region 220. In one instance, and as depicted, a portion 510 that includes the focus point 310 is centered within the viewing region 220. In another instance, the portion 510 can be selected to be substantially similar to the portion 230 (e.g., include items 11-16), or the portion within the viewing region 220 that is substantially similar to portion 230 visible when the focus point 310 was selected. In yet another instance, the portion returned can be arbitrary, random or based on other criteria, wherein the portion includes the focus point 310. In still another instance, the formatting such as scaling can be adjusted to emphasize the focus point 310.

It is to be appreciated that both the slider 240 and the tag 320 can dynamically change in size. For example, if the entity changes in size while being viewed in the UI 200, the slider 240 and the tag 320 can be automatically updated to reflect a present relative position and percentage.

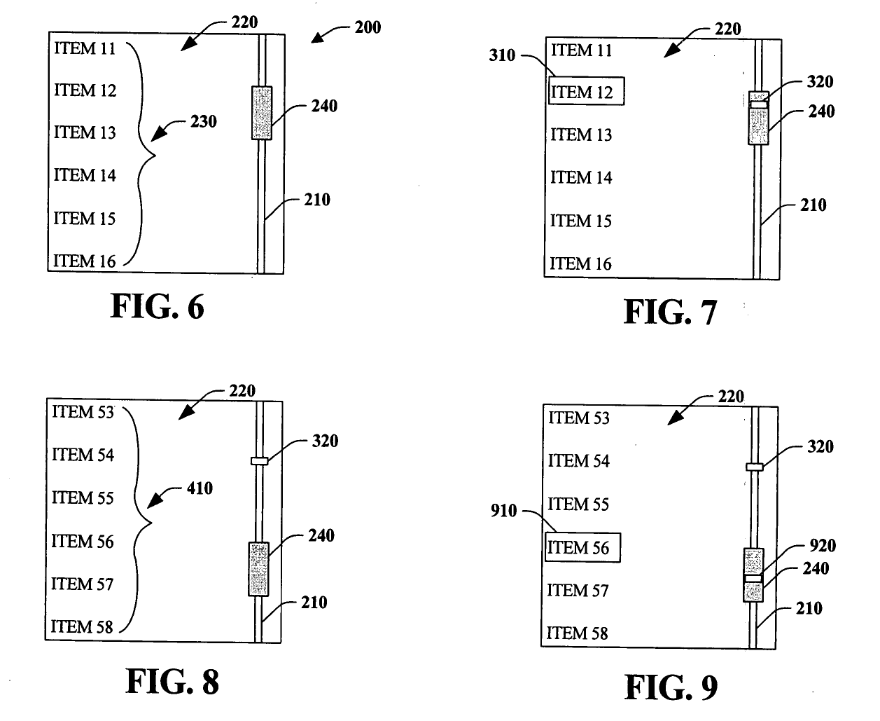

FIGS. 6-9 illustrate the exemplary UI 200, wherein the user can identify more than one focus point, or foci, in accordance with an aspect of the present invention. Referring to FIG. 6, as noted above, the UI 200 comprises the scroll bar 210, the slider 240 and the viewing region 220, which provides a mechanism for the user to view the portion 230.

In general, the scroll bar 210 represents the extent of a list and the slider 240 represents the region within the list that is displayed within the viewing region 220. The position and size of the slider 240 typically are indicative of the location of the displayed portion with the list and the percentage of the displayed portion, respectively. For example, the slider 240 is positioned closer to one end of the scroll bar 210 such that items 11-16 are within the viewing the region 220, which represents approximately a fourth of the list as illustrated by the length of the slider 240 relative to the length of the scroll bar 210. The slider 240 can be moved by the user to navigate through the list and selectively change the portion that it visible within the viewing region 220.

FIG. 7 illustrates the UI 200, wherein the user identifies the focus point 310 within the viewing region 22, which corresponds to “ITEM 12.” Identification can include merely highlighting the item or highlighting the item along with subsequent mouse, key activity and/or audio command. Additionally, identifying the focus point 310 can invoke the creation of the tag 320, which is associated with the scroll bar 210 and the slider 240. The tag 320 provides a graphical representation of the relative position of the focus point 310 within the list and with respect to the slider 240, or portion of the list within the viewing region 220.

FIG. 8 illustrates the UI 200, wherein the portion of the entity displayed within the viewing region 220 has been modified such items 53-58 are displayed within the viewing region 220 and the focus point 310 (“ITEM 12”) is no longer viewable by the user. However, as noted above, the tag 320 provides the user with the relative location of the focus point 310 with respect to the scroll bar 210 and the slider 240.

FIG. 9 illustrates a second focus point 910 and corresponding tag 920 added to the UI 210. The second focus point 910 can be similarly added. For example, the user can identify the second focus 910 by highlighting the “ITEM 56,” for example, in combination with mouse, key activity and/or audio command, wherein the tag 920 is generated and associated with the scroll bar 210 and the slider 240. In other aspects of the present invention, the technique can include additional mechanisms, for example, to indicate whether an additional focus is being selected or whether the new focus should replace a previous focus point.

After identifying the second focus point 910, the user can continue to navigate through the list to view other portions of the list and add more foci. In addition, the user can quickly return to either the focus 310 or the focus 910 via the slider 240 or respective tags 320 and 920, as described in detail above. Furthermore, the user can remove one or more foci and associated tags.

As noted previously, when multiple foci are defined, various techniques can be employed to facilitate determining which tag corresponds to which focus. For example, the tags can be color coded with a default or user-define color scheme. In another example, respective tags can include a number (e.g., 1, 2, 3, etc.) that represents its chronological position with respect to the other tags. In yet another example, the size and shape can vary between tags. In still another example, the tags can be associated with information that provides tag creation date and/or time, and/or a context such as a keyword or phrase.

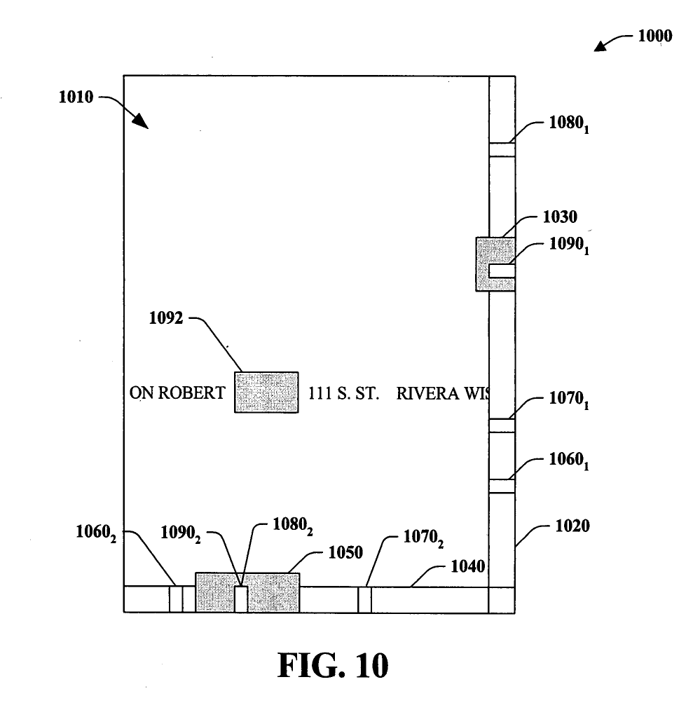

FIG. 10 illustrates an exemplary UI 1000 that utilizes a multi-dimensional approach to identify foci, in accordance with an aspect of the present invention. The UI 1000 comprises a window 1010 in which a user can view at least a portion of data. The window 1010 comprises a first positioning tool 1020 associated with a slider 1030 that allows the user to scroll vertically through data and selectively display at least a portion of data along a vertical axis within the window 1010. The window 1010 further comprises a positioning tool 1040 associated with a slider 1050 that allows the user to scroll horizontally through data and selectively display at least a portion of data along a horizontal axis within the window 1010. It is to be appreciated that the two-scroll bar example is provided for sake of brevity, and that virtually any number of scroll bars can be employed in accordance with an aspect of the invention, wherein scroll bars can represent similar and/or different dimensions.

The user can identify one or more foci within the data, wherein respective foci can reside at various vertical and horizontal locations in the data such that one or more foci can be visible within window 1010, including all foci, or a subset thereof. The UI 1000 is depicted with a plurality of foci associated with a plurality of foci indicators 1060-1090. Respective foci comprise two foci indicators, one associated with the vertical positioning tool 1020 and the other associated with the horizontal positioning tool 1040.

By way of example, a first focus, which is not visible within the window 1010, comprises foci indicators 1060₁ and 1060₂. The focus 1060₁ corresponds to a vertical position and is associated with the vertical positioning tool 1020 and the focus 1060₂ corresponds to a horizontal position and is associated with the horizontal positioning tool 1040. The focus represented by the foci indicators 1060₁ and 1060₂ resides outside of the window 1010 since the indicators 1060₁ and 1060₂ are not concurrently within the vertical and horizontal sliders 1030 and 1050. A second focus, which similarly is not visible within the window 1010, is associated with foci indicators 1070₁ and 1070₂, which are outside of sliders 1030 and 1050. Likewise, a third focus, associated with foci indicators 1080₁ and 1080₂, resides outside of the window 1010, since both foci indicators 1080₁ and 1080₂ are not within the sliders 1030 and 1050.

The first, second or third focus can be displayed within the window 1010 via moving the vertical and/or horizontal sliders 1030 and 1050 such that the foci indicators associated with the desired focus falls within respective sliders 1030 and 1050 or via invoking the foci indicators associate with the desired focus. For example, the user can adjust the sliders 1030 and 1050 until the first or second focus become visible within the window 1010, wherein associated indicators will be proximate the sliders, or adjust the vertical slider 1030 until the third focus becomes visible within the window, since the horizontal slider 1050 is already suitably positioned. In another example, the user can invoke the foci indicators 1060₁-1060₂, which automatically re-positions the data so that the first focus resides within the window 1010. In another example, the user merely invokes one of the foci indicators 1060₁ or 1060₂ to automatically position the focus within the window 1010.

A fourth focus 1092 (“SMITH”) resides within the widow 1010 and is associated with foci indicators 1090₁ and 1090₂, which reside within both sliders 1030 and 1050. As noted previously, the location of the sliders 1030 and 1050 with respect to the scroll bars 1020 and 1040 provides an indication of the relative position of the data displayed within the window 1010 with respect to all the data. Thus, in the example, the data displayed in the window 1010 is located about one third down from the top of the window 1010 and about one third from the left side of the window 1010. In addition, the location of the foci indicators with respect to the sliders 1030 and 1050 provides an indication of the relative position of the focus with respect to the sliders 1030 and 1050. For example, the focus 1092 is located more than half way down from the top of the region displayed in the window 1010, as indicated by the location of the indicator 1090₁ within the slider 1030 and a little less than half way from the left-most region displayed in the window 1010, as indicated by the location of the indicator 1090₁ within the slider 1040.

It is noted that foci indicators can overlap. For example, two or more different foci can be identified that are situated in a similar vertical/horizontal and a substantially different horizontal/vertical location, or vice versa. For example, the foci indicators 1080₂ and 1090₂ overlap within the horizontal positioning tool 1040. Various methods can be employed to distinguish overlapping indicators. In one aspect of the present invention, a technique that toggles through the indicators can be employed. In another aspect of the present invention, a bottom-situated indicator can be a larger size such that at least a portion of respective overlapping indicators is available for selection at any given time. In another aspect of the invention, invoking one of the indicators elicits the generation of a list of the overlapping indicators, wherein the user can select one of the indicators from the list.

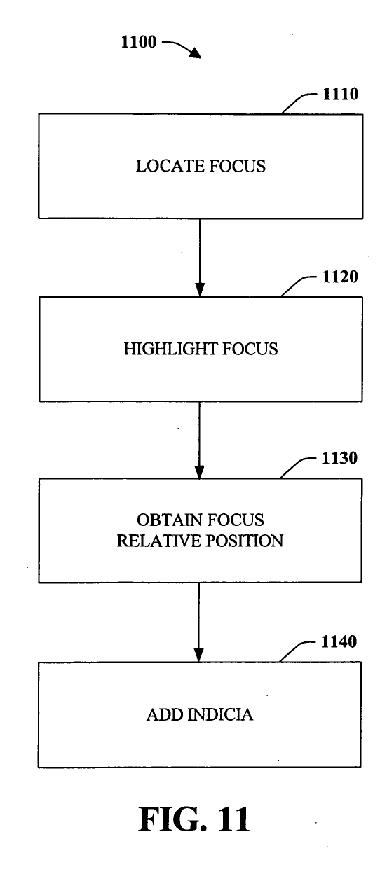

FIGS. 11-14 illustrate methodologies, in accordance with an aspect the present invention. While, for purposes of simplicity of explanation, the methodologies are shown and described as a series of acts, it is to be understood and appreciated that the present invention is not limited by the order of acts, as some acts can, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

FIG. 11 illustrates a methodology 1100 that adds graphical indicia indicative of a relative position of a focus within a list to a positioning mechanism, in accordance with an aspect of the present invention. Proceeding to reference numeral 1110, a user can employ the positioning mechanism (e.g., a slider, thumb control, roller ball, etc.) to locate an area of interest, or focus within the list. In many instances, only a portion of the list can be viewed at any given time within a viewing window; however, it is to be appreciated that the entire list can be viewed and read within the viewing window, if desired.

At reference numeral 1120, the user can identify the focus. It is to be appreciated that any known technique for selecting an item can be employed in accordance with an aspect of the present invention. For example, the user can position a mouse over at least a portion of the focus and subsequently click (e.g., single, double, etc.) on the focus. In another example, the user can employ keystrokes such as arrow keys and connection with keys defined to facilitate selecting items. In yet another example, audio input such as voice selection can be employed. In still another example, a combination of the foregoing can be employed. It is to be understood that the above example are not limitative, but are only provided for explanatory purposes.

Upon selecting (e.g., highlighting) the focus, a signal (e.g., event, IRQ, message, flag, request and the like) can be transmitted to notify a system (e.g., system 100 and 200) that the user desires to bookmark the focus and be provided with graphical indicia that corresponds to the relative location of the focus within the list. The signal can be automatically transmitted, for example, when the selection is complete (e.g., a second event, etc.) and/or manually transmitted, for example, via the user invoking a mechanism to transmit the message. The signal can additionally be associated with information related to the focus such as focus coordinates within the list. Such information can include a mapping from document space to display space, for example, when the coordinate systems differ.

At reference numeral 1130, the signal, along with any additional information, can be employed to determine, or obtain the relative position of the focus within the list. When the position is transmitted with the signal, the position information can be extracted and utilized. In other instances, the signal can elicit a mechanism that determines the position.

At 1140, the position of the focus is utilized to generate the graphical indicia and associate the graphical indicia with the positioning mechanism. For example, where the positing mechanism is a scroll bar with a slider, the graphical indicia can be generated within the scroll bar, wherein the slider can be moved proximate to the indicia such that the focus is visible within the viewing window or the slider can be moved away from the focus such the focus is not visible within the viewing window. The location of the graphical indicia in connection with the scroll bar and slider can provide the user with the relative position of the focus. Thus, the user can quickly locate and return to the focus regardless of the current position of the viewing window within the list.

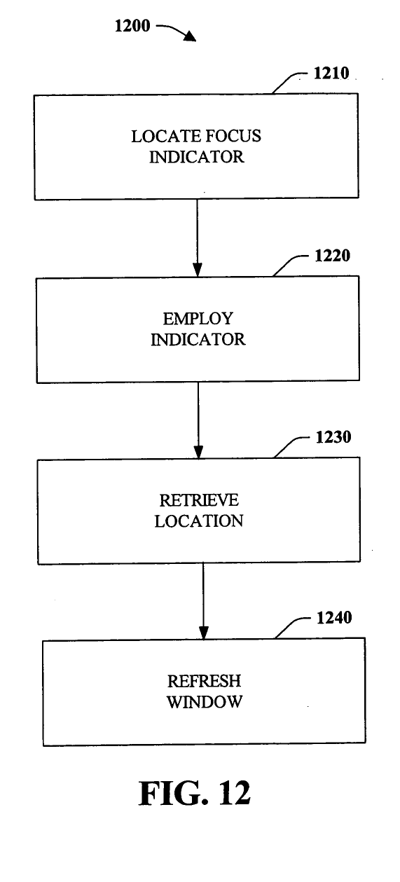

FIG. 12 illustrates a methodology 1200 that employs focus indicia to locate a user-defined item of focus, in accordance with an aspect of the present invention. At reference numeral 1210, the user locates the focus indicia associated with the desired item of focus. For example, in many instances the user can define a plurality of focus indicia, wherein respective focus indicia correspond to different and/or similar items. Commonly, a mechanism can be employed in connection with the focus indicia to provide information indicative of the items of focus. For example, instead of moving to the item of focus, the user can remain at a current location and observe the information indicative of the item of focus to determine which of the plurality of focus indicia is related to the desired item of focus. In one aspect of the invention, the user can simply position a mouse pointer over the focus indicia to obtain text and/or audio information.

Once the focus indicia for the desired item of focus is located, at 1220 the focus indicia can be employed to facilitate retrieving the desired item of focus. For example, the user can invoke the focus indicia, for example, by merely clicking on it. In another example, the user can maneuver a slider (e.g., a semi-transparent and translucent) on a scroll bar over the focus indicia, wherein the user can view the information associated with slider. In yet another example, the user can invoke the indicia via an audio stimulus such as the user's voice.

After invoking the focus indicia, at 1230 the location of the focus indicator is obtained. For example, coordinates associated with the focus indicator can be retrieved. For example, the coordinates can be stored in a bank and associated with a unique identification, wherein the coordinates can be retrieved. At reference numeral 1240, the location can be employed to provide the item of focus to the user. For example, the information that the user is viewing is automatically positioned such that the item of focus is displayed to the user through a viewing window within a user interface.

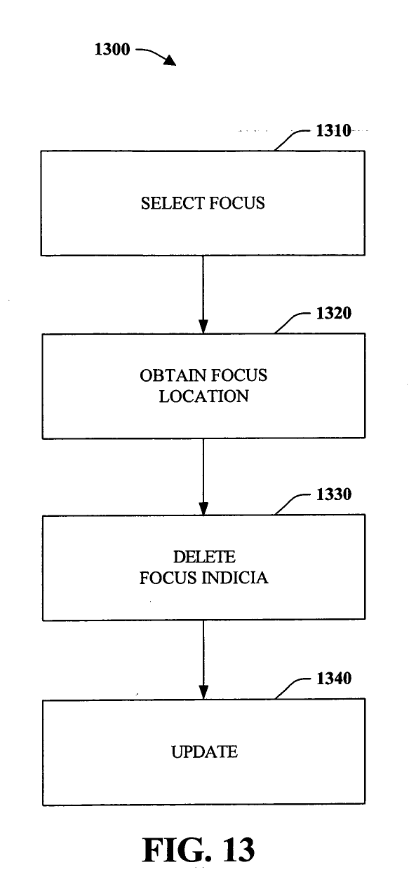

FIG. 13 illustrates a methodology 1300 that removes focus indicia from a scroll bar, in accordance with an aspect of the present invention. Proceeding to reference numeral 1310, the user can select focus indicia for removal. As noted above, a plurality of focus indicia can exist, wherein respective focus indicia correspond to different and/or similar focus items. The user can identify the focus indicia via locating an associated focus item. After locating the focus indicia to remove, at 1320 the location of the associated focus item can be obtained. In one aspect of the invention, the item of focus is positioned within a viewing window so that the user can verify that the desired focus indicia is removed. In another aspect of the invention, the user can configure the settings such that verification is not requested.

At reference numeral 1330, the user can indicate the desire to remove the focus indicia from the scroll bar. It is to be appreciated that the user can select any number of indicia, including all indicia, to concurrently remove. At 1340, the focus indicia can be removed, wherein the scroll bar can be updated to reflect the removal and any highlighting associated with the focus item is concurrently removed. If the user determines to re-establish the focus indicia after removing, the user can employ any known undo, or reverse last action utility.

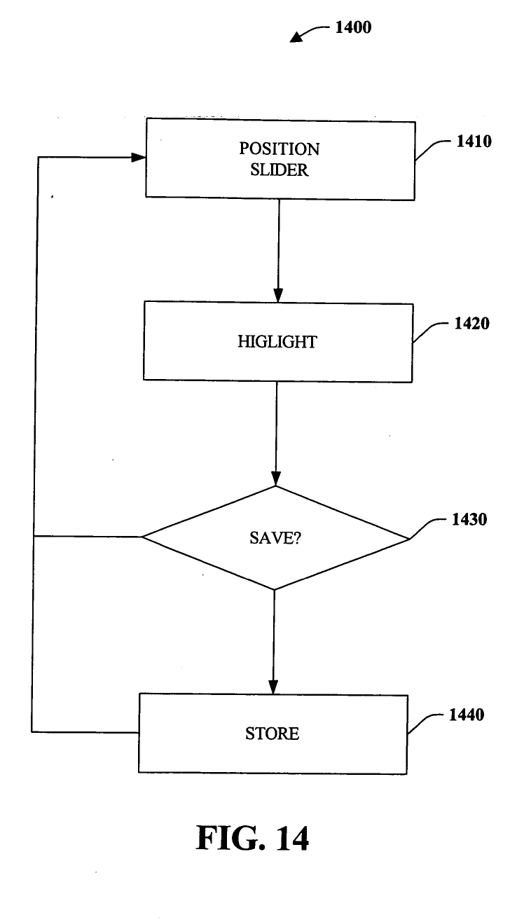

FIG. 14 illustrates a flow diagram 1400 that adds a graphical mark that relates to a position of a focus to a scroll bar and slider, in accordance with an aspect of the present invention. At reference numeral 1410, the user locates the information that the user desires to track, or the focus item via navigating through the information with the slider. In general, the slider allows the user to navigate through substantially all the information, wherein at least a portion of the information can be viewed at any given time through a window, for example. Typically, the user positions the information of interest within the window.

Once the user locates the focus point, at 1420 the user can highlight the information to indicate the desire to track the information. Various highlighting techniques can be employed, as described above. At reference numeral 1430, the user can determine whether to generate a graphical mark for the focus. In general, tracking the focus enables the user the ability to navigate through and read other information while continuing to know the relative location of the focus. Thus, when the user navigates such that the focus is not visible in the window, the user can continue to know the location of the focus.

If the user decides not to generate the graphical mark for the information, the user can remove the highlight from the focus, for example, via unhighlighting the information or merely moving to another section via the slider. The user subsequently can locate other foci to track at 1410. If the user decides to generate the graphical mark for the focus, then at 1440 the graphical mark can be created and associated with the scroll bar. The user can then navigate through other information while maintaining the location of the focus. The user can return to the focus simply by moving the slider to the graphical mark and/or invoking the graphical mark, as described in detail above.

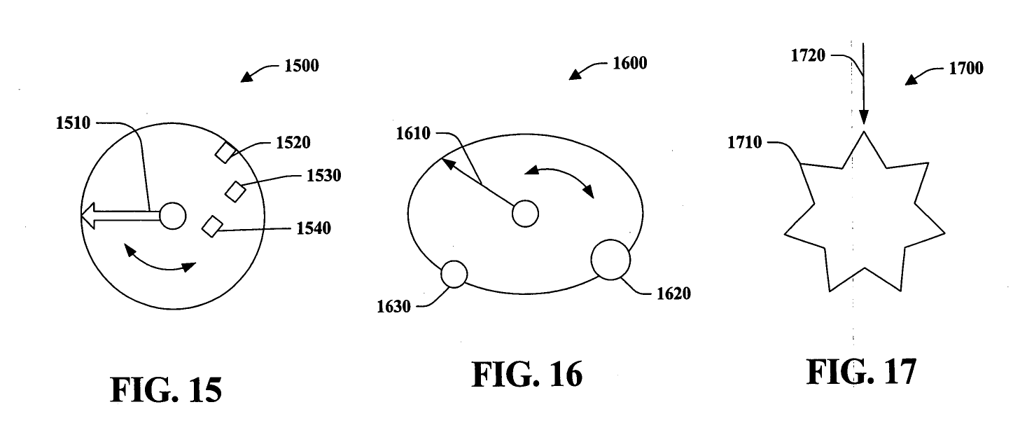

FIGS. 15-17 illustrate variously shaped scroll bars that can be employed in accordance with an aspect of the present invention. Proceeding to FIG. 15, an exemplary circular dial 1500 is illustrated. The circular dial 1500 includes a pointer 1510 that rotates around the dial 1500 as a user navigates through a list. Typically, a 360-degree rotation around the dial 1500 corresponds with traversing the list from beginning to end, or vice versa; however, it is to be appreciated that the dial 1500 can be configured such that only a portion of the rotation angle or multiple rotations can be employed to represent the list.

The dial 1500 further includes a plurality of foci indicators 1520, 1530 and 1540 that indicates respective locations of user-defined points of focus within the list. The focus indicators 1520-1540 provide the user with a relative location of the point of focus

The tracking component 1810 can be substantially similar to the systems 100, 200 and 1000 described above. For example, the tracking component 1810 can accept input indicative of adding a focus point, removing a focus point and/or advancing to a focus point. After receiving the input, the tracking component can add a location, remove a location or retrieve a location associated with a focus point from the storage 1820. Retrieved location can be subsequently utilized to position data so that the user can view the corresponding focus item. The log 1830 can be employed to store a history of all activity associated with adding, removing and returning focus items. In addition, the history can include additional information such as user information, wherein the history of more than one user can be saved and delineated via the user.

The intelligence component 1840 can facilitate identifying focus items, adding focus indicia, and removing focus indicia via inferences. Such inferences generally refer to the process of reasoning about or inferring states of the system, environment, and/or user from a set of observations as captured via events and/or data. In addition, inferences can be employed to identify a specific context or action, or can generate a probability distribution over states, for example. Furthermore, the inference can be probabilistic, for example, the computation of a probability distribution over states of interest based on a consideration of data and events.

Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, etc.) can be employed in connection with performing automatic and/or inferred action in connection with the subject invention.

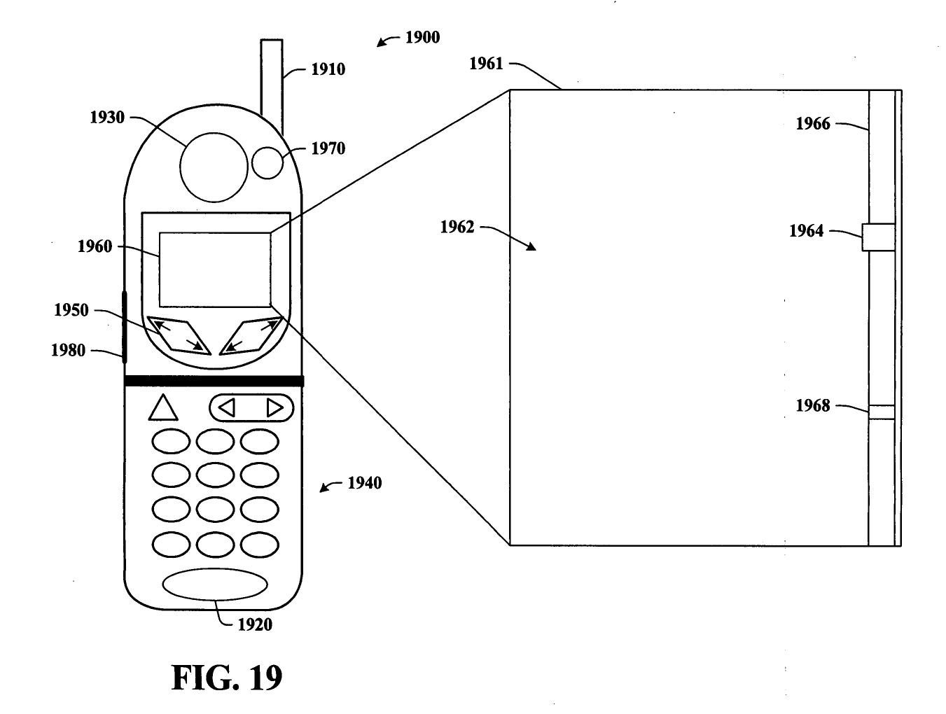

FIG. 19 illustrates an exemplary mobile (e.g., portable and wireless) telephone 1900 that can employ the novel aspects of the present invention. The mobile telephone 1900 comprises an antenna 1910 that communicates (e.g., transmit and receive) radio frequency signals with one or more base stations. The antenna 1910 can be coupled to duplexer circuitry (e.g., as described herein) within the mobile telephone 1900. In addition, the mobile telephone 1900 can include a separate signal-receiving component (not shown) that can also be coupled to the duplexer.

The mobile telephone 1900 further comprises a microphone 1920 that receives audio signals and conveys the signals to at least one on-board processor for audio signal processing, and an audio speaker 1930 for outputting audio signals to a user, including processed voice signals of a caller and recipient music, alarms, and notification tones or beeps. Additionally, the mobile telephone 1900 can include a power source such as a rechargeable battery (e.g., Alkaline, NiCAD, NiMH and Li-ion), which can provide power to substantially all onboard systems when the user is mobile.

The mobile telephone 1900 can further include a plurality of multi-function buttons including a keypad 1940, menu navigating buttons 1950 and on-screen touch sensitive locations (not shown) to allow a user to provide information for dialing numbers, selecting options, navigating the Internet, enabling/disabling power, and navigating a software menue system including features in accordance with telephone configurations.

A display 1960 can be provided for displaying information to the user such as a dialed telephone number, caller telephone number (e.g., caller ID), notification information, web pages, electronic mail, and files such as documents, spreadsheets and videos. The display 1960 can be a color or monochrome display (e.g., liquid crystal, CRT, LCD, LED and/or flat panel), and employed concurrently with audio information such as beeps, notifications and voice. Where the mobile telephone 1900 is suitable for Internet communications, web page and electronic mail (e-mail) information can also be presented separately or in combination with the audio signals.

In one aspect of the present invention, the display 1960 can be utilized in connection with a graphical user interface (GUI) 1961. The GUI 1961 can include a viewing window 1962 where data can be displayed to the user. The user can navigate through the data via a slider 1964 and a scroll bar 1966. In addition, the user can mark areas of interest, or focus areas via the novel aspects of the invention, as described herein, such that the user can navigate to other areas of data and be able to return to the area of interest. Thus, the user can view data that exceeds the bounds of the GUI 1961 via displaying portions the data within the GUI 1961 and marking areas of interest in order to quickly return to such areas as desired. For example, the GUI 1961 can include a focus indicia 1968 associated with an item identified as a point of focus. The user can define the item of focus while the item is visible within the GUI 1961. Then, the user can navigate to another area of the data. When the user desires to return to the focus point, the user can move the slider 1964 over the indicia 1968, which will return the focus item to the GUI 1961 or the user can invoke the indicia 1968 to automatically return the focus item to the GUI 1961.

The menu navigating buttons 1950 can further enable the user to interact with the display information. In support of such capabilities, the keypad 1940 can provide keys that facilitate alphanumeric input, and are multifunctional such that the user can respond by inputting alphanumeric and special characters via the keypad 1940 in accordance with e-mail or other forms of messaging communications. The keypad keys also allow the user to control at least other telephone features such as audio volume and display brightness.

An interface can be utilized for uploading and downloading information to memory, for example, the reacquisition time data to the telephone table memory, and other information of the telephone second memory (e.g., website information and content, caller history information, address book and telephone numbers, and music residing in the second memory). A power button 1970 allows the user to turn the mobile telephone 1900 power on or off.

The mobile telephone 1900 can further include memory for storing information. The memory can include non-volatile memory and volatile memory, and can be permanent and/or removable. The mobile telephone 1900 can further include a high-speed data interface 1980 such as USB (Universal Serial Bus) and IEEE 1994 for communicating data with a computer. Such interfaces can be used for uploading and downloading information, for example website information and content, caller history information, address book and telephone numbers, and music residing in the second memory. In addition, the mobile telephone 900 can communicate with various input/output (I/O) devices such as a keyboard, a keypad, and a mouse.

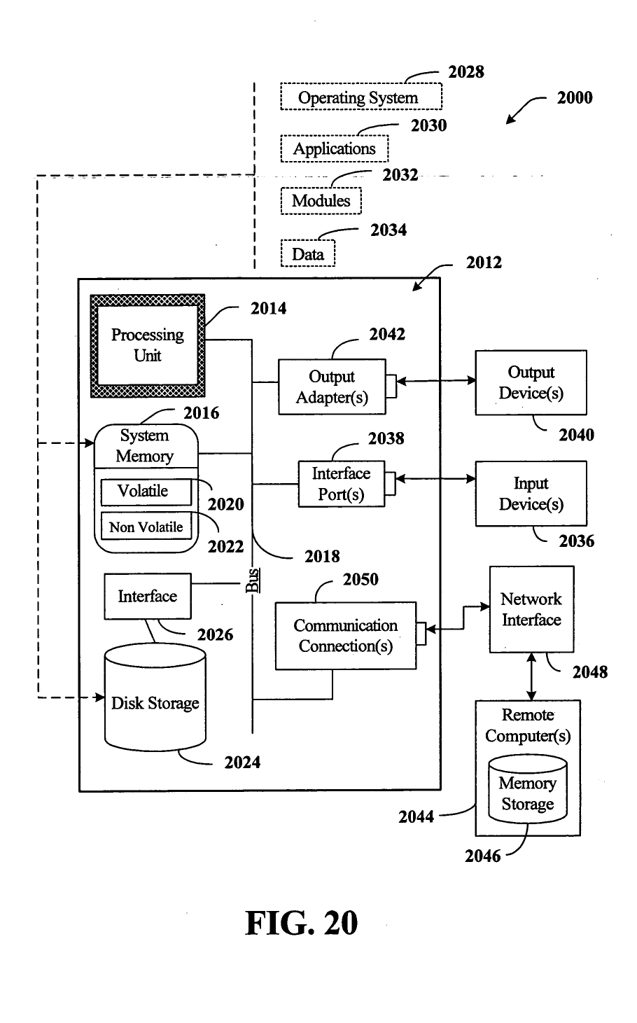

In order to provide a context for the various aspects of the invention, FIG. 20 as well as the following discussion are intended to provide a brief, general description of a suitable computing environment in which the various aspects of the present invention can be implemented. While the invention has been described above in the general context of computer-executable instructions of a computer program that runs on a computer and/or computers, those skilled in the art will recognize that the invention also can be implemented in combination with other program modules. Generally, program modules include routines, programs, components, data structures, etc. that perform particular tasks and/or implement particular abstract data types.

Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practiced on stand-alone computers. In a distributed computing environment, program modules may be located in both local and remote memory storage devices.

With reference to FIG. 20, an exemplary environment 2010 for implementing various aspects of the invention includes a computer 2012. The computer 2012 includes a processing unit 2014, a system memory 2016, and a system bus 2018. The system bus 2018 couples system components including, but not limited to, the system memory 2016 to the processing unit 2014. The processing unit 2014 can be any of various available processors. Dual microprocessors and other multiprocessor architectures also can be employed as the processing unit 2014.

The system bus 2018 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 2016 includes volatile memory 2026 and nonvolatile memory 2022. The basic input/output system (BIOS), containing the basic routines to transfer information between elements within the computer 2012, such as during start-up, is stored in nonvolatile memory 2022. By way of illustration, and not limitation, nonvolatile memory 2022 can include read only memory (ROM), programmable ROM (PROM), electrically programmable ROM (EPROM), electrically erasable ROM (EEPROM), or flash memory. Volatile memory 2020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 2012 also includes removable/non-removable, volatile/non-volatile computer storage media. FIG. 20 illustrates, for example a disk storage 2024. Disk storage 2024 includes, but is not limited to, devices like a magnetic disk drive, floppy disk drive, tape drive, Jaz drive, Zip drive, LS-100 drive, flash memory card, or memory stick. In addition, disk storage 2024 can include storage media separately or in combination with other storage media including, but not limited to, an optical disk drive such as a compact disk ROM device (CD-ROM), CD recordable drive. (CD-R Drive), CD rewritable drive (CD-RW Drive) or a digital versatile disk ROM drive (DVD-ROM). To facilitate connection of the disk storage devices 2024 to the system bus 2018, a removable or non-removable interface is typically used such as interface 2026.

It is to be appreciated that FIG. 20 describes software that acts as an intermediary between users and the basic computer resources described in suitable operating environment 2010. Such software includes an operating system 2028. Operating system 2028, which can be stored on disk storage 2024, acts to control and allocate resources of the computer system 2012. System applications 2030 take advantage of the management of resources by operating system 2028 through program modules 2032 and program data 2034 stored either in system memory 2016 or on disk storage 2024. It is to be appreciated that the present invention can be implemented with various operating systems or combinations of operating systems.

A user enters commands or information into the computer 2012 through input device(s) 2036. Input devices 2036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 2014 through the system bus 2018 via interface port(s) 2038. Interface port(s) 2038 include, for example, a serial port, a parallel port, a game port, and a universal serial bus (USB). Output device(s) 2040 use some of the same type of ports as input device(s) 2036. Thus, for example, a USB port may be used to provide input to computer 2012, and to output information from computer 2012 to an output device 2040. Output adapter 2042 is provided to illustrate that there are some output devices 2040 like monitors, speakers, and printers, among other output devices 2040, which require special adapters. The output adapters 2042 include, by way of illustration and not limitation, video and sound cards that provide a means of connection between the output device 2040 and the system bus 2018. It should be noted that other devices and/or systems of devices provide both input and output capabilities such as remote computer(s) 2044.

Computer 2012 can operate in a networked environment using logical connections to one or more remote computers, such as remote computer(s) 2044. The remote computer(s) 2044 can be a personal computer, a server, a router, a network PC, a workstation, a microprocessor based appliance, a peer device or other common network node and the like, and typically includes many or all of the elements described relative to computer 2012. For purposes of brevity, only a memory storage device 2046 is illustrated with remote computer(s) 2044. Remote computer(s) 2044 is logically connected to computer 2012 through a network interface 2048 and then physically connected via communication connection 2050. Network interface 2048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 2050 refers to the hardware/software employed to connect the network interface 2048 to the bus 2018. While communication connection 2050 is shown for illustrative clarity inside computer 2012, it can also be external to computer 2012. The hardware/software necessary for connection to the network interface 2048 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications, and variations that fall within the spirit and scope of the appended claims.

1. A system that tracks a focus point within data, comprising:
a detection component that obtains a position of the focus point within the data;
a storage component that saves the position; and
a tracking component that retrieves the position from the storage component and utilizes the position to locate the focus point within the data.

2. The system of claim 1, the detection component further receives an input associated with one of begin tracking the focus point, end tracking the focus point and return to the focus point.

3. The system of claim 2, the input comprising one of an event, an IRQ, a signal, flag, a request, and an audio stimulus.

4. The system of claim 2, the input further comprising one or more of the position of the focus point and a unique identification of the focus point.

5. The system of claim 1, the position of the focus point comprising one or more coordinates of the focus point relative to the data.

6. The system of claim 1, the data comprising one of a file, a document, a spreadsheet, a table, a list, a chart and a file structure.

7. The system of claim 1, further comprising a removal component that deletes the position of the focus point from the storage component after one of receiving a user request to delete the position, a time lapse and a period of inactivity.

8. The system of claim 1 is employed in connection with a graphical user interface.

9. A user interface that graphically tracks a user-identified item of interest, comprising:
a viewing region that provides the user a window to observe at least a portion of information from a set of information;
a scroll bar that maps to the set of information;
a slider associated with the scroll bar that is moved relative to the scroll bar to determine the at least a portion of information that is displayed within the viewing region; and
a component that obtains a location of the user-identified item of interest, generates a graphical indicator for the item of interest and maps the graphical indicator to the scroll bar to provide the user with a visible indication of the location of the item of interest within the set of information.

10. The system of claim 9, the scroll bar is oriented in one of an orthogonal, a parallel, an acute and an obtuse angle with respect to an axis of the viewing region.

11. The system of claim 9, the user identifies the item of interest by highlighting the item via at least one of a mouse, a keystroke and an audio stimulus.

12. The system of claim 9, the user removes the graphical indicator from the scroll bar via one of unhighlighting the item of interest and deleting the graphical indicator.

13. The system of claim 9, the user returns to the item of interest via one of moving the slider proximate to the graphical indicator and invoking the graphical indicator.

14. The system of claim 13, the graphical indicator is invoked via one or more of a mouse, a keystroke and an audio stimulus.

15. The system of claim 13, invoking the graphical indicator automatically returns the item of interest within the viewing region.

16. The system of claim 9, the user changes the item of interest by moving the graphical indicator.

17. The system of claim 9, the component further employed to generate and associate graphical indicators for one or more additional user-identified items of interest.

18. The system of claim 9, the graphical indicator is visible within the slider when the item of interest is visible within the viewing window.

19. The system of claim 9, the graphical indicator dynamically changes in size in response to a change in size in the set of information in order to maintain a relative indication of the percentage of information represented by the graphical indicator relative to the set of information.

20. The system of claim 9, further comprising one or more additional scroll bars that are employed in connection with one or more additional sliders to provide for multi-dimensional tracking of the item of interest.

21. The system of claim 9, further comprising an intelligence component that facilitates adding and removing the graphical indicator and returning the item of interest to the viewing region.

22. The system of claim 21, the intelligence comprising at least one of a statistic, a probability, an inference and a classifier.

23. A method that adds graphical indicia related to a point of focus to a scroll bar, comprising:
receiving an input associated with a user-identified point of focus within a list;
obtaining a location of the user-identified point of focus within the list; and
adding a first graphical indicator to the scroll bar, the first graphical indicator provides a relative location of the user-identified point of focus within the list.

24. The method of claim 23, further comprising adding a second graphical indicator to the scroll bar, the second graphical indicator is associated with a second user-identified point of focus within the list.

25. The method of claim 24, the second graphical indicator is differentiated from the first graphical indicator by at least one of color, size, shape and position.

26. The method of claim 23, further comprising positioning a pointer proximate to the graphical indicia to obtain information indicative of the point of focus.

27. A method that returns a point of focus to a user, comprising:
selecting a graphical indicator that is associated with the point of focus;
obtaining a position of the point of focus from the graphical indicator; and
utilizing the position to locate the point of focus Within data.

28. The method of claim 27, further comprising positioning a pointer over the graphical indicator to obtain information indicative of the point of focus in order to facilitate selecting the desired graphical indicator from a plurality of graphical indicators.

29. The method of claim 27, further comprising invoking the graphical indicator to automatically return the point of focus to the user.

30. The method of claim 27, further comprising manually navigating a slider proximate to the graphical indicator to return the point of focus to the user.

31. A system that graphically tracks user-identified foci, comprising:
means for identifying foci;
means for generating graphical indicia associated with the foci;
means for associating the graphical indicia with a positioning mechanism; and
means for employing the positioning mechanism in connection with the graphical indicia to view the foci.
